(19) United States
(12) Patent Application Publication
(10) Pub. No.: US 2026/0109577 A1
(43) Pub. Date: Apr. 23, 2026

(54) DRIVETRAIN ARRANGEMENT FOR A DRIVE UNIT OF AN ELEVATOR SYSTEM AND CORRESPONDING SHAFT AND USE THEREOF

(71) Applicant: TK ELEVATOR INNOVATION AND OPERATIONS GMBH, Düsseldorf (DE)

(72) Inventors: Andreas Wilhelm, Aichelberg (DE); Aleksandr Gentner, Wendlingen (DE); Andreas Frank, Filderstadt (DE); Christian Friedrich, Weissach (DE); Alexander Wölfel, Stutgart (DE); Florian Otto, Filderstadt (DE)

(21) Appl. No.: 19/118,105

(22) PCT Filed: Sep. 25, 2023
(86) PCT No.: PCT/EP2023/076417

§ 371 Date: Apr. 3, 2025

(30) Foreign Application Priority Data
Oct. 5, 2022 (DE) 10 2022 125 717.7

(51) Int. Cl. B66B 11/04

(52) U.S. Cl. CPC B66B 11/0476

(57) ABSTRACT

The present disclosure provides for a drivetrain arrangement for a drive unit of an elevator system. The drive unit includes at least one belt drive, with a shaft mounted in a housing in a fixed bearing and in a movable bearing. The fixed bearing can be/become secured in an axially fixed manner on the shaft without a bearing cover in several circumferential positions in each case via at least one disc interacting with the housing. A reservoir is configured between the bearings and a brake unit to receive bearing grease. An inner diameter of the fixed bearing is smaller than or greater than an inner diameter of the movable bearing such that in the axial assembly direction, the bearing with the larger inner diameter can be brought over the shaft portion intended for the bearing with the smaller inner diameter. This simplifies the assembly and implementation of the drive.

### CROSS-REFERENCE TO RELATED APPLICATIONS

This application is a National Phase Entry under 35 U.S.C. § 371 of International Patent Application Serial No. PCT/EP2023/076417 filed Sep. 25, 2023, which claims the benefit of and priority to German Application Serial No. 10 2022 125 717.7 filed Oct. 5, 2022, the entire contents of both which are incorporated by reference in the present disclosure.

### TECHNICAL FIELD

The present disclosure relates to a drivetrain arrangement for a drive unit such as a belt drive unit of an elevator system.

### BACKGROUND

In traction machines for elevator systems, a material-efficient and space-saving design, among other things, is also of interest; this is also true of traction machines having a belt drive. A belt drive for an elevator system has a shaft which is mounted in a housing and has a driving zone, via which the belt is guided and the torque is transmitted by the shaft. The shaft is mounted or supported in bearings on both sides of the driving zone. A suitable design in each case of the drivetrain, on the one hand with regard to installation and mounting of the shaft, and on the other hand also with regard to material use and space requirements, whether in general or whether application-specific, has to be determined. The used/usable belt is predetermined in particular by performance parameters, and therefore the task of the designer is, among other things, to design the driving zone for different power levels or different drivetrains which are as scalable as possible in such a way or to provide design guidelines that are as generally valid as possible to the effect that the above-mentioned requirements can all be met as synergistically as possible.

According to the prior art, the shaft is provided as standard in a more or less standardized configuration for the functional integration and mounting for the drivetrain. Proceeding therefrom, there is interest in an improved way of designing and integrating the shaft in the drivetrain, i.e. in technical teaching that permits optimization of the design of the shaft and components interacting therewith, in particular in the region of the driving zone and in connection with the mounting of the shaft.

The following publications describe shafts having axial securing means engaging on the shaft: DE 10 2021 003 240 A1, U.S. Pat. No. 4,482,194 A.

Proceeding from the prior art, there is a need for further design optimization of the drivetrain of a belt drive for elevator systems, in particular with regard to the mounting and functional integration of the shaft in the drivetrain. Not least, in particular with regard to potential savings in connection with the resources used for the design, there is also interest in technical teaching which can be used as scalably as possible for the (design) optimization of those sections of the drivetrain that interact with the shaft.

### SUMMARY

It is an object to provide a drivetrain arrangement for a drive unit of an elevator system, in which an advantageous design and configuration of bearings, shaft and housing receiving the shaft permit an advantageous symbiosis of the requirements with regard to installation, mounting, lubrication and also an active braking function, which is optionally implementable on the shaft, in particular also in conjunction with the optimization of drive units comprising at least one belt drive. It is also an object to design the drivetrain arrangement in such a way that the shaft is not only optimizable in a simple manner with regard to mounting and installation, but also with regard to operating conditions or operating parameters, with regard to bearing lubrication and an optionally desired braking function. Not least, it is also an object to design the shaft of such a drivetrain arrangement in such a way that, with the simplest possible installation of the shaft, lubrication can be highly reliably ensured independently of or in combination with a braking function, in respect of an optimized bearing function during the subsequent (long-term) operation.

This object is achieved by a drivetrain arrangement according to the embodiments described herein. The features of the exemplary embodiments described below can be combined with one another, unless explicitly stated otherwise. The present disclosure is based on several aspects which may also be (but do not have to be) realized in combination with one another; all these aspects contribute to achieving the object of the present disclosure, at least to the extent that the operation of the shaft in the drivetrain can in each case be improved with a design of the individual components of the drivetrain to be as slender as possible, such as by measures being proposed uniformly relating to the mounting or the bearings of the shaft and components connected thereto.

A drivetrain arrangement for a drive unit/belt drive unit of an elevator system is provided, having a shaft mounted in at least two bearings, such as a fixed bearing and a movable bearing, in a housing.

According to the disclosure, it is proposed that at least one component (e.g., a bearing ring) of at least one of the bearings, of the fixed bearing or the corresponding component of the fixed bearing, is secured in an axially fixed manner on the shaft without a bearing cover in a plurality of circumferential positions in each case by at least one washer interacting with the housing. This renders the use of a bearing cover superfluous and permits a comparatively slender design.

The disclosure is also based on the concept of using the housing as extensively as possible in order to position or to secure the individual components relative to one another, if possible without the need for expensive additional components in addition to the housing. In other words, the present disclosure teaches that, instead of a specific bearing cover, standard cost-neutral (not noticeable) installation aids, such as plain washers, are used in order to avoid a comparatively expensive manufacturing of bearing covers.

The washers described here, e.g. in a configuration as plain washers (or the corresponding arrangement thereof), such as in a classic fixed/movable bearing arrangement, can fix the fixed bearing in the housing in a highly advantageous way. Classically, the fixed bearing is fixed by a bearing cover; in many applications, this bearing cover is provided either as a solid turned part or as a circular metal sheet, i.e., is a component to be provided separately. By contrast, the present disclosure makes it possible to secure the bearing in question solely by the washers which are widely available and do not require an individual design and which, for example, lie against or are brought into contact with the outer ring of the bearing, on the one hand, and with the housing, on the other hand. For example, the washers are axially secured by being fixed on the end face of the housing from the outside and being brought to preloading by fasteners such as screws, said fasteners such as screws also being able to be secured against unintentional loosening by customary methods (e.g., by means of adhesive, lock washers or similar equivalent means). The bearing seat can also be designed in such a way that the bearing protrudes minimally and the respective washer can fix the bearing by a certain installation preloading force; in this respect, preloading and a secure axially tight seat can also be ensured by a/the inherent stress (elasticity or material thickness) of the washers. Sealing of the drivetrain or the housing is not the function of the washers here; rather, bearings which are already sealed can advantageously be used. In this respect, the washers essentially provide axial securing/preloading (fixing of the bearing in question). It has been shown that the fixing concept according to the disclosure can also be implemented in all those installation situations for the bearings described here, in which sealed bearings are provided or can potentially be used, and even if sealing of the bearings is not required at all.

An installation method is known from the prior art, in which a bearing cover is not already mounted in the interim, but after installation of the bearing, is mounted in interaction with the bearing inner ring and by a screw-in connection on the shaft so as to transmit axial force and cover the end face. By contrast, the arrangement according to the disclosure no longer requires a bearing cover, but can ensure securing of the corresponding bearing component by means of washers fastenable directly to the housing, e.g., by screwing three plain washers acting on an outer ring of the bearing to the housing. In other words: the corresponding end-face shaft end can remain open.

Advantageously, the present disclosure can be implemented in drive units in an embodiment in the form of belt drive units. As described here, an “(absolute) driving zone width” should be understood as meaning in particular the contact surface or running surface usable by the (respective) belt acting around the shaft. In the event that the driving zone is divided into at least two or three driving zone sections, the (absolute) driving zone width is also understood here as meaning a longitudinal section of the shaft, which is constructively considered for the configuration of shoulders or (central) webs for guiding the respective belt; thus, the (absolute) driving zone width is then composed of the widths of the individual driving zone sections and the widths of the webs or shoulders provided for guiding the belts (or at least their constructively intended minimum width, e.g. 10% of the width of the respective driving zone section, for example 5 mm per shoulder or web). Accordingly, in the case of two driving zone sections, an (absolute) driving zone width is obtained from the sum of the width of the two driving zone sections and the width of the central web and the width of the two limiting shoulders. In this respect, the term “driving zone width” should also be understood as meaning a constructive length specification for the length section of the shaft, in particular between two bearing sections, to be correspondingly constructively included for the correct functioning of the at least one belt.

The present disclosure relates to a drivetrain arrangement for a drive unit such as a belt drive unit) of an elevator system having a shaft mounted in at least two bearings, one in a fixed bearing and one a movable bearing, in a housing; wherein at least one component of at least one of the bearings can be secured in an advantageous manner on the shaft without a bearing cover. The present disclosure furthermore relates to a development for such a drivetrain arrangement to the effect that the functioning of a brake unit can be improved by a reservoir receiving bearing grease or similar lubricant. The present disclosure furthermore relates to a development for such a drivetrain arrangement to the effect that the inner diameters of the bearings are dimensioned depending on each other in such a way that, in the axial installation direction, the bearing with the larger inner diameter can be applied via the shaft section provided for the bearing with the smaller inner diameter. In this respect, the present disclosure relates to an optimization of the arrangement and functional integration and support/mounting of the shaft in the drivetrain. Furthermore, the present disclosure in each case also relates to the use of a correspondingly designed shaft in particular in a drivetrain of an elevator system. In particular, the disclosure relates to a device according to the preamble of the respective independent claim.

The “drivetrain arrangement” should be understood here as meaning in particular the torque-transmitting components which interact with a motor and in particular also with a/the at least one belt of a belt drive unit, in particular also with a feather key and/or at least one toothing (shaft-hub connections in general); depending on the configuration of the shaft and the bearings and the desired installation sequence, the drivetrain arrangement may also comprise bearing components or all of the bearings. Depending on the definition, the drivetrain arrangement may also comprise the motor or drive of the belt drive unit.

A “shoulder” should be understood here as meaning a lateral delimitation of the entire driving zone, which is preferably designed integrally in one-piece on the shaft, “(shaft) shoulder”, or which can optionally also be connected to the shaft in the sense of an additional washer (attachment component) (compare in this respect what are referred to as flanged pulleys in standard belt drives). Unless expressly described otherwise here, the shoulder is preferably formed integrally in one piece on the shaft, i.e., is formed by material machining on the shaft.

A “web” should be understood here as meaning an elevation for dividing the driving zone into individual driving zone sections, in particular for coupling to a plurality of belts, which are each intended to run separately from one another on only one of the driving zone sections because of the web. Also, unless expressly described otherwise here, the respective web is preferably formed integrally in one piece on the shaft, “(shaft) web”.

The shoulders and webs described here can also, inter alia, fulfil the function of providing an abutment/stop/rolling surface for a belt holding-down unit.

An “(absolute) belt width” refers here to the accumulated width of the belts being used, i.e., for example, three belts three times the width of the individual belt (assuming that all belts are exactly the same width).

A “belt drive unit” should be understood here as meaning in particular a traction machine by which force can be transmitted from a/the motor to at least one traction means designed as a belt, the belt drive unit being designed for receiving, mounting and supporting a shaft interacting with the at least one traction means. Although the shaft can also be regarded as part of the belt drive unit, according to one of the exemplary embodiments, however, the belt drive unit is designed to receive different shafts (e.g., depending on power level or depending on a predefined or desired number of belts), and therefore the belt drive unit can also be provided without a shaft. The belt drive unit comprises at least the housing receiving or at least holding the shaft and the motor or drive.

The “driving zone diameter” here is the maximum diameter of a circumferential surface of the driving zone or of the corresponding driving zone section (in the case of a plurality of belts), on which the belt interacts as intended with the shaft. Usually, the circumferential surface of the driving zone is not strictly cylindrical, but slightly spherical (centering function for the belt); therefore, the diameter that characterizes the largest diameter usually in the central region of the driving zone or of the corresponding driving zone section should be understood here as the driving zone diameter.

Personified terms, unless worded in the neuter here, may apply to all sexes in the context of the present disclosure. Any English-language expressions or abbreviations used here are industry-standard expressions in the art and are familiar in English to a person skilled in the art.

According to one exemplary embodiment, the at least one component (e.g., a bearing ring) of the at least one bearing, such as the fixed bearing or a bearing ring of the fixed bearing, is secured in the plurality of circumferential positions in each case by fixing the at least one washer to the housing, with the washer in a radially overlapping arrangement between the housing and outer ring of the bearing in question. This facilitates easy assembly and good accessibility, and allows the fastener to be arranged in an advantageous (non-interfering) region of the housing.

According to one exemplary embodiment, the in each case at least one washer in the plurality of circumferential positions comes to bear against a/the outer ring of the bearing in question (e.g., the fixed bearing). This also permits direct exertion and transmission of an axial securing force from the fastener (e.g., screws) to the bearing.

According to one exemplary embodiment, the washers are uniformly distributed symmetrically over the circumference, in at least three circumferential positions. This also favors a distribution of force which is as uniform as possible and thus also an as exact arrangement as possible of the corresponding bearing.

According to one exemplary embodiment, the at least one washer provided in the respective circumferential position is fixed by a screw or an equivalent fastener with the respective screw in axial alignment at least approximately parallel to the shaft and on the outside of the housing. In addition to an advantageous force flux path, such an arrangement also favors good accessibility.

According to one exemplary embodiment, at least three bores or similar cutouts which are uniformly distributed over the circumference and are intended for receiving the fastener such as screws, fixing the washers are formed in an end-face section of the housing, in which the bearing in question (e.g., the fixed bearing) is mounted. This means that the respective fastening position can also be unambiguously predefined or visibly predetermined for a fitter.

According to one exemplary embodiment, in an end-face section of the housing, in which the bearing in question (e.g., the fixed bearing) is mounted, the shaft terminates with an end-face end (at least approximately flush in a/the same radial plane) and, together with the bearing in question, seals the corresponding housing feedthrough. This also provides an elegant housing end with a design which is as highly slender as possible.

Advantageously, a/the drivetrain arrangement is provided in particular for a drive unit/belt drive unit of an elevator system in a configuration having a shaft mounted in at least two bearings in a housing, such as in a fixed bearing and a movable bearing, and with a brake unit acting on the shaft, wherein the drivetrain arrangement has a reservoir arranged between the bearings and the brake unit and designed for receiving bearing grease, wherein the reservoir is arranged and configured (such as integrally on the housing) such that bearing grease is driven from the/from an adjacent bearing or from the at least two bearings into the reservoir by centrifugal force; for example the drivetrain arrangement including the features of a drivetrain arrangement described here. In this respect, it is also proposed in the context of the present disclosure to take precautions on the housing to the effect that not only a bearing seat which is as exact as possible or the correct bearing position can be ensured with good certainty, but also that the long-term functioning can be ensured with minimized maintenance effort, in particular by at least partially self-maintaining/self-regulating operation. This also further optimizes the entire drivetrain configuration to the effect that the mounting can be optimized both in terms of design and operation by means of comparatively simple but nevertheless synergistic measures.

The brake unit (or at least one brake disk) is connected to the shaft for conjoint rotation, e.g. in a splined section on a shaft end next to one of the bearings, and can interact with an end face of the housing, for example.

The disclosure is also based on the concept that the shaft has to be further machined only as little as possible and that at least some of the intended range of functions can also be integrated in the housing. In other words, the disclosure envisages an interaction of housing and shaft not only with regard to the type and manner of the mounting, but also with regard to individual operating functions at least including the lubrication, in particular at an axial position of the shaft in front of a brake unit.

Grease leaked does not need to be drained off; rather, the reservoir can be dimensioned in such a way that the grease which is contained in the bearing (or the maximum possible quantity that can escape) can (could) be completely received in the reservoir, in particular cannot (could not) reach the/a brake unit. It is provided that the grease/oil is driven radially outward by centrifugal force and, driven by gravity, collects at the bottom of the reservoir, i. e, can flow along the circumferential surface of the reservoir; from this lowest point with respect to the direction of gravitational force, further use of this lubricating medium may be selectively (optionally) provided.

For example, the grease reservoir has a circular-segment-shaped, such as semicircular, cross-sectional geometry in the radially outer region (e.g., in a ring-like design). In this case, the relative position relative to the/a brake unit can be selected in such a way that grease/oil is prevented from reaching a brake disk or to sections interacting therewith. The grease reservoir can be provided on all existing bearings; the most effective arrangement is between the brake-side bearing and the brake. In this respect, it is sufficient if the grease reservoir is provided only on one axial side.

The present disclosure also enables a most cost-effective, material-efficient and sustainable mounting and the lubrication required for this purpose, wherein a comparatively secure functioning of a/the brake unit can also be ensured (e.g., without further measures being required).

According to one exemplary embodiment, the reservoir is provided integrally in one piece on the housing, and is formed/configured exclusively by the housing. This promotes functional decoupling from the shaft and can further streamline the shaft design.

According to one exemplary embodiment, the reservoir is designed in a ring-like manner with circular-segment-shaped or ellipse-segment-shaped cross-sectional geometry and is arranged with a radial extent extending radially outward at least beyond the adjacent bearing in such a way that bearing grease escaping from the at least one bearing is driven radially outward into the reservoir when the shaft rotates (i.e. given corresponding centrifugal forces). Not least, this can also ensure a good collecting and retaining function.

According to one exemplary embodiment, the reservoir is arranged on a housing end face, which is provided for the arrangement of a brake disk, in the first axial section adjacent to the housing end face. This facilitates the smooth interaction of lubrication measures and braking function.

According to one exemplary embodiment, the reservoir (when the bearings/shaft are/is installed as intended) is arranged between the bearing and the brake unit axially directly next to one of the bearings and axially directly next to the brake unit. This relative position proves to be particularly effective.

According to one exemplary embodiment, a/the lowest point of the reservoir is arranged at least 5%, and may be in some embodiments at least 10%, further radially on the outside than the radius of a/the outer ring at least of the adjacent bearing. This favors a/the self-regulating effect described here with regard to the removal of lubricant, in particular to avoid contamination of a/the brake unit.

According to one exemplary embodiment, at least one driving zone for at least one belt of the drive unit is formed on the shaft, wherein the at least one driving zone is arranged between the bearings. The reservoir can also ensure that the belt is protected from lubricating medium.

According to one exemplary embodiment, the reservoir (when the bearings/shaft are/is installed as intended) is arranged between the fixed bearing and the brake unit (apart from an axial ring or similar bearing seat section), such as axially directly next to the fixed bearing and axially directly next to the brake unit. This also favors a particularly effective accommodating of lubricant.

According to one exemplary embodiment, a felt ring or similar lubricant collecting element is arranged in an arrangement between the reservoir and a bearing inner ring, so as to fill the axial section in between. This can also further increase the effectiveness of the reservoir arrangement.

Advantageously, a/the drivetrain arrangement is provided in particular for a drive unit of an elevator system including at least one belt drive having a shaft mounted in a housing in at least two bearings, such as a fixed bearing and a movable bearing, wherein at least one driving zone for at least one belt of the drive unit is formed on the shaft between the bearings; wherein a/the inner diameter of the fixed bearing is smaller or greater than a/the inner diameter of the movable bearing and differs from the inner diameter of the other bearing in such a way that, in the axial installation direction, the bearing with the larger inner diameter can be applied (can be slid, can be mounted), without contact, via the shaft section provided for the bearing with the smaller inner diameter; the drivetrain arrangement including the features of a drivetrain arrangement described here. The outer diameters of the bearings can also differ from one another in such a way that installation of the shaft in the housing with bearings preassembled on the shaft is simplified, such as at least approximately analogously to the diameter variation described here using the example of the inner diameter. Apart from this, the size of the respective bearing can also be varied in such a way that an inner diameter differs to a greater or lesser extent from the inner diameter of the other bearing than is realized for the outer diameters (e.g., based on bearing rings of differing thickness or balls or rolling bodies). In this way, an optimum can be found specifically for the respective interface (on the one hand to the shaft, on the other hand to the housing). A person skilled in the art can note these variation possibilities and implement them in an application-specific manner. In this respect, it is also proposed within the scope of the present disclosure to undertake measures with regard to the dimensioning of the bearing seats in order to be able to further optimize the mounting and, in particular, to facilitate installation. The present disclosure therefore teaches that even with comparatively symmetrical bearing loading in both bearing sections, the dimensioning can differ, in particular to the effect that the shaft does not need much machining and is not overdimensioned with regard to the load rating of the bearing correspondingly used.

The disclosure is also based on the concept of implementing bearings of different sizes with a variation in size only insofar as a/the loading, which according to expectations is primarily uniformly distributed, does not lead to overdimensioning and nevertheless the installation advantages which can be realized with the different bearing sizes can be ensured. In other words, the two bearing sizes, although different, are nevertheless approximated or adjusted as closely as possible (i.e., in a certain sense, they are also standardized as far as possible).

In classic electric motors, the axle loading at the (two) bearings can vary comparatively greatly; in particular, in classic electric motors, the axle loading on the output side is usually much higher than on the averted side. Especially in the case of a drive for an elevator system (elevator systems), the axle loading is generally to be assumed to be very high, but is substantially uniformly distributed (at least in the case of belt drives); conventionally, a symmetrical construction of the shaft relative to the driving zones is realized to date, which results in comparable loadings at the corresponding bearings. Especially also in this context, the disclosure makes it possible to find an optimum for realizing bearings which are as far as possible similar in terms of size and load rating, but which are nevertheless different. The corresponding bearing diameter can also be selected or predetermined in such a way that the shaft has to be (re-)machined as little as possible and does not have to be overdimensioned with regard to the load rating. Not least, this also provides cost advantages. A bearing arrangement without a bearing cover can also be implemented (regardless of the individually selected/optimized bearing diameter).

According to one exemplary embodiment, the inner diameters of the bearings differ from each other (only) in such a way that re-machining of the shaft is minimized/can be minimized. This design approach helps to take into account the fact that a large diameter variation is associated with a disadvantageously high outlay on machining the material.

According to one exemplary embodiment, the inner diameters of the bearings differ from one another in such a way that, in the axial installation direction, the bearing with the larger inner diameter can be applied (can be slid, can be mounted) via a/the shaft section configured as at least one driving zone, in particular in at least two or three driving zones predetermined by shaping of the shaft. Not least, this also favors a very advantageous installation.

According to one exemplary embodiment, the inner diameter of the fixed bearing is smaller than the inner diameter of the movable bearing. This configuration or this size distribution proves to be advantageous, especially with regard to the belt drive units described here.

According to one exemplary embodiment, the smaller bearing is arranged between the driving zone and a/the brake unit acting around the shaft. Not least, this also favors an advantageous installation situation.

The drive unit described here is designed or configured as a belt drive unit with at least one belt engaging on at least one driving zone of the shaft, with at least two or three driving zones and a corresponding number of belts.

The above-mentioned object is also achieved by an elevator system having at least one drive unit described here.

The aspects of the disclosure described here can be realized individually or in combination with one another. In this respect, the above-mentioned object is also achieved by use of a shaft which can be mounted in at least two bearings, such as in a fixed bearing and a movable bearing, in a housing for coupling drive components of a drivetrain arrangement of an elevator system for coupling at least one belt of a drive unit/belt drive unit to at least one component to be driven of the elevator system, wherein at least one component of at least one of the bearings, in particular of the fixed bearing, is secured in an axially fixed manner on the shaft without a bearing cover in a plurality of circumferential positions in each case by at least one washer interacting with the housing, wherein the shaft has at least one of the following features in particular in combination with one another: the housing has a reservoir arranged (when the bearings/shaft are/is installed as intended) between the bearings and a splined section of the shaft, which splined section is provided for a brake unit, and designed for receiving bearing grease, and/or wherein a/the inner diameter of the fixed bearing is smaller or greater than a/the inner diameter of the movable bearing use of the shaft in a drivetrain arrangement described here. This enables above-mentioned advantages to be realized, particularly with regard to an approach that takes into account both the installation situation and the (long-term) operation of the drive unit.

The above-mentioned object is thus also achieved by a drivetrain arrangement described here, produced by dimensioning and arranging the shaft and housing in such a way that the washers securing a/the corresponding bearing in an axially fixed manner come to bear against the end face of the housing, and by material-recessing formation of a/the reservoir receiving bearing grease, come to bear at least against the housing (and optionally also against the shaft in a corresponding axial section), and optionally additionally also by material-removing machining of a/the shaft section provided for the bearing with the smaller inner diameter. This allows the above-mentioned advantages to be realized, especially with regard to optimizing the design of the mounting of the shaft.

Summary: The present disclosure provides an improved drivetrain arrangement in particular for a drive unit of an elevator system, in which the drive unit includes at least one belt drive, having a shaft mounted in a housing in a fixed bearing and a movable bearing; in this case, the fixed bearing can be secured in an axially fixed manner on the shaft without a bearing cover in a plurality of circumferential positions in each case by means of at least one washer interacting with the housing. Advantageously, a reservoir is arranged between the bearings and a brake unit of the drivetrain arrangement and designed for receiving bearing grease. Advantageously, a/the inner diameter of the fixed bearing is smaller or greater than a/the inner diameter of the movable bearing in such a way that, in the axial installation direction, the bearing with the larger inner diameter can be applied via the shaft section provided for the bearing with the smaller inner diameter. This facilitates the installation and implementation of the drive, in conjunction with at least one driving zone provided on the shaft between the bearings, and the operation of the drive is optimized. The features and aspects described here can also be advantageously combined with one another, with each aspect in itself already providing the advantages correspondingly described here.

### BRIEF DESCRIPTION OF THE FIGURES

In the following figures of the drawing, the disclosure will be described in more detail, wherein, for reference signs not explicitly described in a respective figure of the drawing, reference is made to the other figures of the drawing. In the figures:

FIG. 1 shows in a perspective side view a first type of shaft configured for a drivetrain arrangement according to exemplary embodiments;

FIG. 2 shows in a perspective side view a second type of shaft configured for the drivetrain arrangement according to exemplary embodiments;

FIG. 3 shows in a perspective side view a third type of shaft configured for the drivetrain arrangement according to exemplary embodiments;

FIG. 4 shows in a sectional side view a shaft configured for a drivetrain arrangement according to an exemplary embodiment;

FIG. 5 shows in a schematic illustration a drivetrain arrangement according to exemplary embodiments that is coupled to an elevator system;

FIG. 6A shows in a perspective side view of a belt drive unit side of a motor with a shaft or drivetrain arrangement according to exemplary embodiments;

FIG. 6B shows in a perspective side view pf the a belt drive unit of FIG. 6A from an opposite side view according to exemplary embodiments;

FIG. 7 shows in perspective view a belt drive unit configured for a drivetrain arrangement according to exemplary embodiments, in particular for elevator systems;

FIG. 8A shows in a side view a shaft of a drivetrain arrangement mounted in a housing according to exemplary embodiments;

FIG. 8B shows in a side view a shaft of a drivetrain arrangement mounted in a housing according to exemplary embodiments; and

FIG. 9 shows in a schematic illustration in a partially sectioned view a shaft configured for a drivetrain arrangement according to exemplary embodiments.

### DETAILED DESCRIPTION OF THE FIGURES

The disclosure will firstly be explained with general reference to all the reference signs and figures. Special features or individual aspects or aspects of the present disclosure that are clearly visible/presentable in the respective figure will be addressed individually in conjunction with the respective figure.

Provision is made of a drivetrain arrangement 10 for a belt-drive unit (traction machine) 20 for driving an elevator car 1 of an elevator system 100, wherein a drive 23 is coupled via a shaft 13 to at least one belt 21. The shaft 13 is mounted in a housing 19 in a first bearing 11 (e.g., fixed bearing) and a second bearing 12 (e.g., movable bearing) in a first bearing section 13.1 and a second bearing section 13.2, wherein the at least one belt 21 is guided in a driving zone 13.4 which optionally comprises multiple sections 13.5, each delimited by at least one shoulder 13.3 or by a web 13.3a. At one of the shaft ends, a splined section 13.6 in particular for a rotationally conjoint arrangement of a component of a brake unit 17 can be provided, and at the other shaft end, a feather key section 13.7 or a comparable rotationally-conjoint coupling in relation to the rotor of the drive 23 can be provided.

The following reference signs denote in detail individual size-related or positional indications, wherein reference is made to the radial direction (r) and to the longitudinal direction x (axial direction):
B13 width or length section (absolute) between bearing seats/bearing surfaces; b13.3 width of an individual shoulder; b13.3a width of the individual central web; B13.4 absolute driving zone width comprising all driving zone sections and also the webs/shoulders provided for delimitation; b13.5 width of the individual driving zone section (with an average proportion of the web/shoulder); b21 width of the individual belt, B21 absolute belt width of all the belts used;
shaft diameter D0 at the first end of the shaft (such as in the splined section); shaft diameter D1 in the first bearing section in particular directly adjacent to the driving zone, except for one shoulder; (first) shoulder diameter D2 (or shaft diameter in the region of a first shoulder); driving zone diameter D3 (or shaft diameter in the region of the driving zone); (middle) web diameter D4 (or shaft diameter in the region of a web); (second) shoulder diameter D5 (or shaft diameter in the region of a second shoulder); shaft diameter D6 in the second bearing section in particular directly adjacent to the driving zone, except for one shoulder; shaft diameter D7 at the second shaft end (such as in the feather key section, rotor coupling section); the absolute length of the shaft is referred to here as L13.

It is of note that the respective (shaft) shoulder 13.3, according to the present disclosure, is in the form of a one-sidedly separating step for limiting the belt movement (axial degree of freedom of movement), and that a/the (shaft) web 13.3a is provided as a central web in terms of configuration, that is to say acts in a separating manner on both sides and accordingly also provides an axial stop for two respective belts (the conceptual distinction that is selected here should also be understood in this respect). It is optionally also possible for provision to be made for axial delimitation 13.8 of the feather key section, such as by a shaft shoulder step, which, however, may be of significantly flatter form than the shoulders described here for delimiting the driving zone.

Guides, screens or guide plates 19.9 of this type for neat coupling-in/-out of the belt(s) can be provided on the housing.

In the following text, special features of the disclosure will be explained with reference to individual figures or exemplary embodiments.

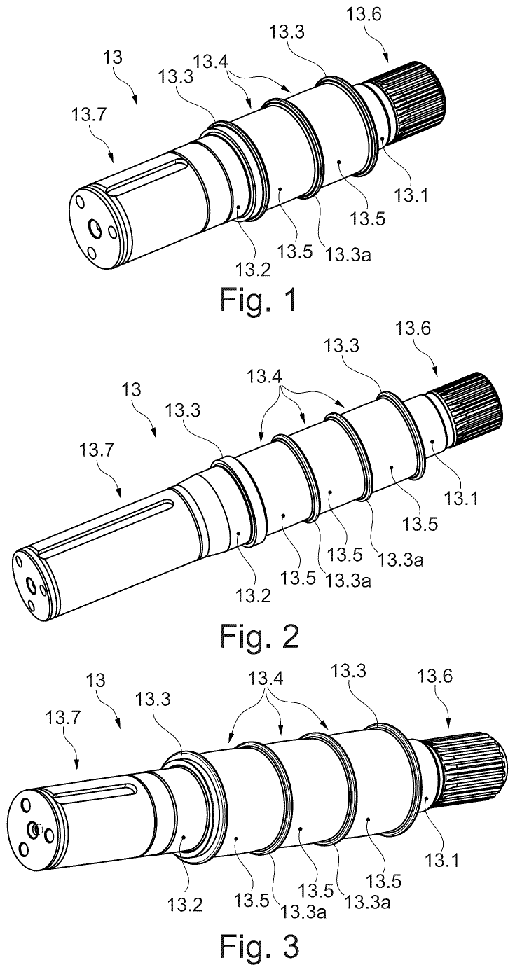

FIG. 1 shows a first type of shaft having the features according to the disclosure (belts not illustrated); the driving zone 13.4 has two driving zone sections 13.5 which are separated from one another by a web 13.3a.

FIG. 2 shows a second type of shaft having the features according to the disclosure (belts not illustrated); the driving zone 13.4 has three driving zone sections 13.5.

FIG. 3 shows a third type of shaft having the features according to the disclosure (belts not illustrated); the driving zone 13.4 has three driving zone sections 13.5. This type differs slightly from the type shown in FIG. 2 with regard to the design of the shoulder 13.3 and the bearing section 13.2 between the feather key section 13.7 and the driving zone 13.4.

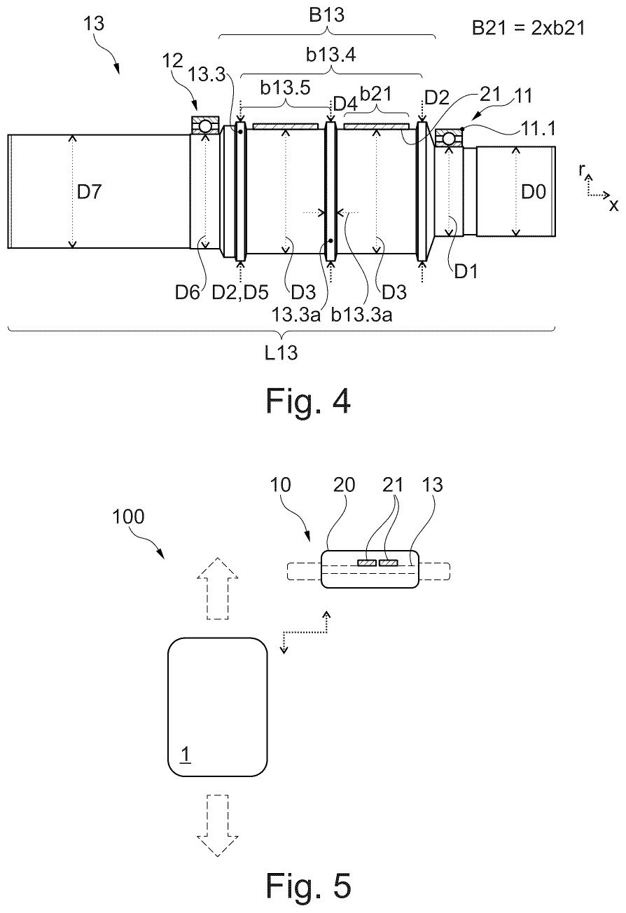

FIG. 4 shows a shaft having the features according to the disclosure with belts 21 lying against each other in the driving zone, with the individual size-related and position-related details being explained in detail. It is emphasized in FIG. 4 that the absolute belt width B21 in the case of (as provided here) two belts used corresponds to the double individual belt width b21, assuming that the belts used are the same width (B21=2×b21).

FIG. 5 shows, roughly schematically, an interaction between the elevator cabin 1 and drivetrain arrangement 10. The shaft described here is installed in the drivetrain arrangement 10. The positional relationship of the components shown is deliberately not specified here; in this regard, a person skilled in the art can provide an application-specific implementation.

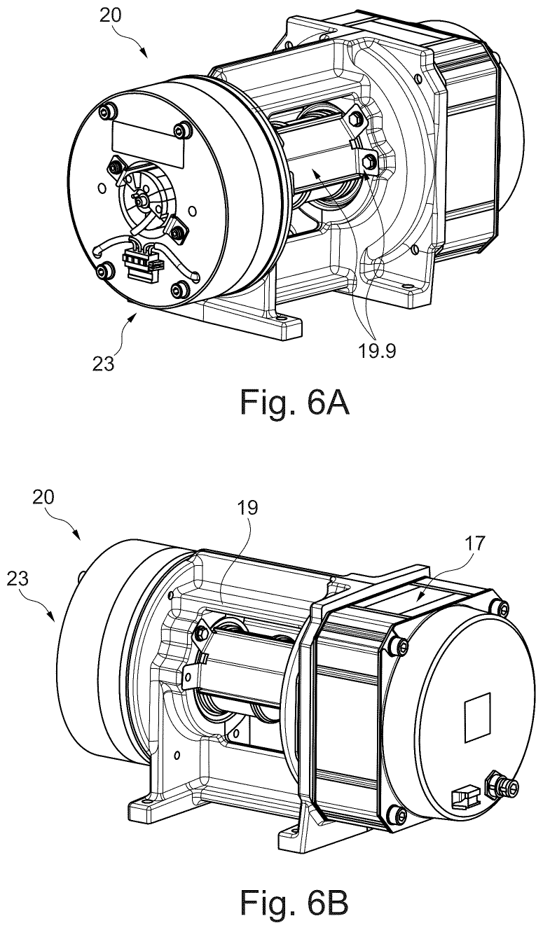

FIG. 6A shows the belt drive unit 20 on the side of the motor 23; in FIG. 6B, the opposite side provided for the arrangement of the brake unit 17 is visible. It can be seen from FIGS. 6A-6B that the driving zone is largely arranged centrally and the entire belt drive unit 20 is comparatively compact.

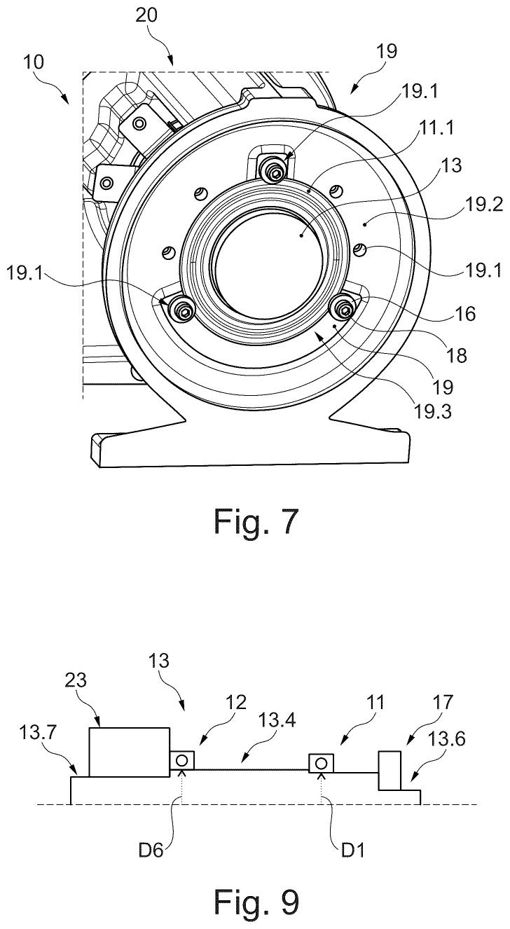

It can be seen in FIG. 7 that the bearing or the bearing ring 11.1 thereof can be advantageously held by three washers 16, which can be clamped between the housing and the bearing ring by means of screws 18 secured on the housing 19 in the axial direction. On the housing, corresponding (threaded) bores 19.1 are formed in an abutment section provided for the washers, such as concentrically around a/the housing feedthrough 19.3 for the shaft 13. A/the brake surface section 19.2 provided for interaction with the brake unit (not shown) can also be formed on the same end face. In this respect, the fastener 18 can also be recessed below said braking plane 19.2; the housing provides the corresponding recesses for this purpose.

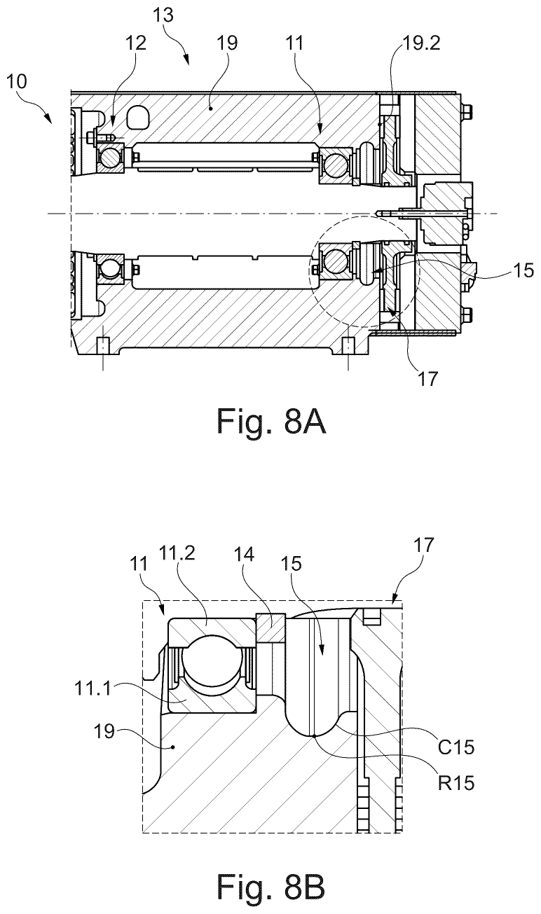

FIGS. 8A and 8B show details regarding an advantageous relative arrangement of the reservoir 15. FIG. 8A shows an advantageous configuration of the reservoir 15 by integral formation in the housing 19, such as directly axially next to a step for the outer ring of the bearing 11 in question. FIG. 8B shows the region indicated in FIG. 8A by the dashed line circle in detail. The reservoir 15 is arranged directly next to the brake unit 17, axially adjoins the brake unit and a brake disk optionally interacting with the housing, i.e., protects said brake disk particularly effectively against lubricating medium (oil/grease) escaping from the bearings. The contour C15 or the cross-sectional geometry of the reservoir 15 is advantageously (at least approximately) semicircular in this example, with a groove or an additional depression also being able to be provided at a lowest point R15, in the sense of a predefined collection point for the lubricating medium.

FIG. 8B also shows in detail a felt ring 14 or similar collecting/receiving element, which is arranged in an arrangement between the reservoir 15 and bearing inner ring 11.2, so as to fill the axial section inbetween. In this way, the operation of the reservoir 15 can be predetermined even more exactly: the oil/lubricating medium is stopped in the axial direction in the region of the shaft, and accordingly has to take the path in the axial direction via the reservoir, i.e., does not pass along the circumferential surface of the shaft in the axial direction to the brake. Such an arrangement of a felt ring (or an equivalent fluid receiving element) can further improve the effectiveness of the reservoir and protect the brake unit even more effectively.

FIG. 9 shows, in a schematic illustration, the basic structure of a/the shaft 13 described here; the bearing sections for the two bearings 11, 12 differ in size in diameter, and also the outer diameters of the bearings (or the corresponding diameters in the housing) can be designed to match the size. Optionally, the fixed bearing 11 is smaller in diameter but larger in terms of the bearing rings and rolling bodies than the movable bearing 12.

1. A drivetrain arrangement for a drive unit/belt drive unit of an elevator system, comprising:
a shaft mounted in at least two bearings in a housing; wherein at least one component of at least one of the bearings is secured in an axially fixed manner on the shaft without a bearing cover in a plurality of circumferential positions in each case by at least one washer interacting with the housing.

2. The drivetrain arrangement according to claim 1, wherein the at least one component of the at least one bearing is secured in the plurality of circumferential positions in each case by fixing the at least one washer to the housing with the respective washer in a radially overlapping arrangement between the housing and an outer ring of the respective bearing.

3. The drivetrain arrangement according to claim 2, wherein the in each case at least one washer in the plurality of circumferential positions comes to bear against the outer ring of the respective bearing.

4. The drivetrain arrangement according to claim 2, wherein each of the at least one washer are uniformly distributed symmetrically over the circumference.

5. The drivetrain arrangement according to claim 1, wherein the at least one washer provided in the respective circumferential position is fixed by a fastener in axial alignment at least approximately parallel to the shaft and on the outside of the housing.

6. The drivetrain arrangement according to claim 5, wherein at least three bores or similar cutouts which are uniformly distributed over the circumference and are configured for receiving the fastener fixing the washers are formed in an end-face section of the housing, in which the bearing in question is mounted.

7. The drivetrain arrangement according to claim 1, wherein in an end-face section of the housing, in which the respective bearing is mounted, the shaft terminates with an end-face end and, together with the respective bearing, seals the corresponding housing feedthrough.

8. The drivetrain arrangement according to claim 1, further comprising: a brake unit acting on the shaft, wherein the drivetrain arrangement has a reservoir arranged between the bearings and the brake unit and is configured for receiving bearing grease, wherein the reservoir is arranged and configured such that bearing grease is driven from an adjacent bearing or from the at least two bearings into the reservoir by centrifugal force.

9. The drivetrain arrangement according to claim 8, wherein the reservoir is provided integrally in one piece on the housing.

10. The drivetrain arrangement according to claim 9, wherein the reservoir is designed in a ring-like manner with circular-segment-shaped or ellipse-segment-shaped cross-sectional geometry and is arranged with a radial extent extending radially outward at least beyond the adjacent bearing in such a way that bearing grease escaping from the at least one bearing is driven radially outward into the reservoir when the shaft rotates.

11. The drivetrain arrangement according to claim 10, wherein the reservoir is arranged on a housing end face, which is provided for the arrangement of a brake disk, in the first axial section adjacent to the housing end face.

12. The drivetrain arrangement according to claim 11, wherein the reservoir is arranged between the bearing and the brake unit axially directly next to one of the bearings and axially directly next to the brake unit.

13. The drivetrain arrangement according to claim 12, wherein a lowest point of the reservoir is arranged at least 5%, further radially on the outside than the radius of an outer ring at least of the adjacent bearing.

14. The drivetrain arrangement according to claim 8, wherein at least one driving zone for at least one belt of the drive unit is formed on the shaft, wherein the at least one driving zone is arranged between the bearings.

15. The drivetrain arrangement according to claim 8, wherein the reservoir is arranged between a fixed bearing and the brake unit to be axially directly next to the fixed bearing and axially directly next to the brake unit.

16. The drivetrain arrangement according to claim 15, wherein a felt ring is arranged in an arrangement between the reservoir and a bearing inner ring so as to fill the axial section in between.

17. The drivetrain arrangement according to claim 1, wherein the drive unit of the elevator system comprises:
at least one belt drive, wherein at least one driving zone for at least one belt of the drive unit is formed on the shaft between the bearings;
wherein an inner diameter of a fixed bearing of the at least two bearings is smaller or greater than an inner diameter of a movable bearing of the at least two bearings and differs from the inner diameter of the other bearing in such a way that, in the axial installation direction, the bearing with the larger inner diameter can be applied without contact, via a shaft section of the shaft provided for the bearing with the smaller inner diameter.

18. The drivetrain arrangement according to claim 17, wherein the inner diameters of the bearings differ from each other in such a way that re-machining of the shaft is minimized.

19. The drivetrain arrangement according to claim 17, wherein the inner diameter of the fixed bearing is smaller than the inner diameter of the movable bearing.

20. The drivetrain arrangement according to claim 17, wherein the smaller bearing is arranged between the driving zone and a brake unit.

21. The drivetrain arrangement according to claim 17 wherein at least one two or three driving zone for corresponding number of belts is formed on the shaft between the bearings.

22. (canceled)

23. A method for a use of a shaft mounted in at least two bearings in a housing for coupling drive components of a drivetrain arrangement of an elevator system, the method comprising:
coupling at least one belt of a drive unit/belt drive unit to at least one component to be driven of the elevator system, wherein at least one component of at least one of the bearings is a fixed bearing secured in an axially fixed manner on the shaft without a bearing cover in a plurality of circumferential positions in each case by at least one washer interacting with the housing, wherein the shaft has at least one of the following features in combination with one another: the housing has a reservoir arranged between the bearings and a splined section of the shaft, which splined section is provided for a brake unit, and designed for receiving bearing grease, or wherein an inner diameter of the fixed bearing is smaller or greater than an inner diameter of the movable bearing.

24. The method of claim 23, wherein dimensioning and arranging the shaft and housing is produced in such a way that the washers securing a/the corresponding bearing in an axially fixed manner come to bear against an end face of the housing, and by material-recessing formation of the reservoir receiving bearing grease, come to bear at least against the housing, and optionally additionally also by material-removing machining of a shaft section provided for the bearing with the smaller inner diameter.
